(19) United States
(12) Patent Application Publication
(10) Pub. No.: US 2012/0199785 A1
(43) Pub. Date: Aug. 9, 2012

(54) TRANSITION METAL PHOSPHATE, AND SODIUM SECONDARY BATTERY

(75) Inventor: Maiko Saka, Tsukuba-shi (JP)

(73) Assignee: SUMITOMO CHEMICAL COMPANY, LIMITED, Chuo-ku, Tokyo (JP)

(21) Appl. No.: 13/500,524

(22) PCT Filed: Oct. 5, 2010
(86) PCT No.: PCT/JP2010/067812

§ 371 Date: Apr. 5, 2012

(30) Foreign Application Priority Data
Oct. 8, 2009 (JP) 2009-234101

(51) Int. Cl. H01M 4/58; C01B 25/30

(52) U.S. Cl. 252/182.1; 423/306

(57) ABSTRACT

The present invention provides a transition metal phosphate and a sodium secondary battery. The transition metal phosphate contains Na, P and M where M represents one or more elements selected from the group consisting of transition metal elements, wherein a value of I/I₀ determined by the following powder X-ray diffraction measurement is 0.6 or less: the powder X-ray diffraction measurement is a method in which an X-ray diffraction pattern is produced by delivering a Cu Kα ray to a mixture composed of the transition metal phosphate and silicon in a transition metal phosphate:silicon weight ratio of 8:1, and then a value of I/I₀ is determined by dividing I by I₀ where I is the intensity of a maximum peak of the transition metal phosphate and I₀ is the intensity of the maximum peak of the silicon in the X-ray diffraction pattern.

### TECHNICAL FIELD

The present invention relates to a transition metal phosphate, and more particularly relates to a transition metal phosphate to be used for a positive electrode active material in a sodium secondary battery.

### BACKGROUND ART

A lithium secondary battery, which is a nonaqueous electrolyte secondary battery, has already been put into practical use as a small-sized power supply for use in a portable telephone and a notebook personal computer. There have been increasing demands for a secondary battery as a large-sized power supply for use in an electric automobile and a dispersion-type power storage.

Since lithium, which is used in the lithium secondary battery, is not abundant in resources, the drying up of lithium resources is worried about in the future. On the contrary, sodium, which is classified as an alkali metal element in the same manner as in lithium, is abundant in resources in comparison with lithium, and is more inexpensive by one digit than lithium. If a sodium secondary battery can be used in place of a lithium secondary battery, it becomes possible to produce a large number of large-sized secondary batteries, such as secondary batteries for automobiles and for dispersion-type power storages, without worrying about exhaustion in resources. As the positive electrode active material for use as the positive electrode for a sodium secondary battery, a substance, which has high crystallinity, and can be doped and dedoped with sodium ions, has been known. Patent Documents 1 and 2 disclose a transition metal phosphate that is represented by a general formula, NaₓM_{y}PO₄ (wherein M represents a transition metal), and has high crystallinity, and the transition metal phosphate is obtained by carrying out a heating treatment on a corresponding material at a high temperature of 550° C. or more.

### PRIOR-ART DOCUMENTS

### Patent Document

### [Patent Document 1] JP2004-533706A

### [Patent Document 2] JP2008-260666A

### DISCLOSURE OF THE INVENTION

The sodium secondary battery produced using a transition metal phosphate in the above-mentioned prior art as the positive electrode active material is not desirable from the viewpoints of discharge capacity and rate characteristics. An objective of the present invention is to provide a sodium secondary battery having an improved discharge capacity and rate characteristics and a transition metal phosphate desirably used as its positive electrode active material. The present inventors have found that a sodium secondary battery, manufactured using a transition metal phosphate having low crystallinity as its positive electrode active material, makes it possible to improve both of the discharge capacity and rate characteristics.

The present invention provides the following means:

<1> A transition metal phosphate comprising Na, P and M where M represents one or more elements selected from the group consisting of transition metal elements, wherein a value of I/I₀ determined by the following powder X-ray diffraction measurement is 0.6 or less: the powder X-ray diffraction measurement is a method in which an X-ray diffraction pattern is produced by delivering a Cu Kα ray to a mixture composed of the transition metal phosphate and silicon in a transition metal phosphate:silicon weight ratio of 8:1, and then a value of I/I₀ is determined by dividing I by I₀ where I is the intensity of a maximum peak of the transition metal phosphate and I₀ is the intensity of the maximum peak of the silicon in the X-ray diffraction pattern.
<2> The transition metal phosphate according to <1>, wherein a full width half maximum of the maximum peak of the transition metal phosphate in the X-ray diffraction pattern is from 0.3° to 1.5°.
<3> The transition metal phosphate according to <1> or <2> being represented by the following formula (1):

NaₓM_{y}PO₄ (1)

wherein x is more than 0 and not more than 1.5, y is from 0.8 to 1.2, and M represents one or more elements selected from the group consisting of transition metal elements.
<4> The transition metal phosphate according to any one of <1> to <3> having an orthorhombic crystal structure.
<5> The transition metal phosphate according to <4>, wherein the space group of the orthorhombic crystal structure is a space group Pnma and the maximum peak of the transition metal phosphate in the X-ray diffraction pattern belongs to a (121) plane of the space group Pnma.
<6> The transition metal phosphate according to any one of <1> to <5> having a BET specific surface area of from 40 m²/g to 80 m²/g.
<7> The transition metal phosphate according to any one of <1> to <6>, wherein the M comprises Fe or Mn or both.
<8> An electrode comprising the transition metal phosphate according to any one of <1> to <7>.
<9> A sodium secondary battery comprising the electrode according to <8> as a positive electrode.

### BRIEF DESCRIPTION OF THE DRAWINGS

FIG. 1 shows one example of an X-ray diffraction pattern in the present invention.

### MODES FOR CARRYING OUT THE INVENTION

### <Transition Metal Phosphate>

The transition metal phosphate of the present invention is a transition metal phosphate having Na, P and M where M represents one or more elements selected from the group consisting of transition metal elements, wherein a value of I/I₀ determined by the following powder X-ray diffraction measurement is 0.6 or less: the powder X-ray diffraction measurement is a method in which an X-ray diffraction pattern is produced by delivering a Cu Kα ray to a mixture composed of the transition metal phosphate and silicon in a transition metal phosphate:silicon weight ratio of 8:1, and then a value of I/I₀ is determined by dividing I by I₀ where I is the intensity of a maximum peak of the transition metal phosphate and I₀ is the intensity of the maximum peak of the silicon in the X-ray diffraction pattern.

Although the transition metal phosphate of the present invention has low crystallinity, it provides a sodium secondary battery having a high discharge capacity with superior rate characteristics.

In the powder X-ray diffraction measurement, silicon is a Si standard sample. The X-ray diffraction pattern is obtained by delivering a Cu Kα ray to a mixture composed of the transition metal phosphate and silicon in a transition metal phosphate:silicon weight ratio of 8:1. More specifically, by using a powder X-ray diffractometor, an X-ray diffraction pattern can be produced by delivering a Cu Kα ray to the mixture under the following conditions.

X-ray source: Cu Kα ray
Voltage-Current: 40 kV-140 mA
Measuring angle range: 2θ=10 to 90°

### Step: 0.02°

Scanning speed: 4°/min
Divergence slit width (DS): 1°
Scattering slit width (SS): 1°
Light receiving slit width (RS): 0.3 mm

A value of I/I₀ is determined by dividing I by I₀ where I is the intensity of a maximum peak of the transition metal phosphate and I₀ is the intensity of the maximum peak of the silicon in the X-ray diffraction pattern. In the present invention, the value of I/I₀ is 0.6 or less. The maximum peak of silicon appears in the vicinity of 2θ=28° in the X-ray diffraction pattern, and belongs to a (111) plane of the cubic crystal structure. When the value of I/I₀ exceeds 0.6, the effects of the present invention are hardly obtained. From the viewpoint of further improving the effects of the present invention, the value of I/I₀ is preferably 0.5 or less, and more preferably 0.4 or less. The value of I/I₀ is preferably 0.1 or more.

From the viewpoint of further improving the effects of the present invention, a full width half maximum of the maximum peak of the transition metal phosphate in the X-ray diffraction pattern is preferably from 0.3° to 1.5°, more preferably from 0.4° to 1.5°, and still more preferably from 0.4° to 1.0°.

From the viewpoint of further increasing the discharge capacity of a secondary battery, the transition metal phosphate of the present invention is represented by the following formula (1):

NaₓM_{y}PO₄ (1)

wherein x is more than 0 and not more than 1.5, y is from 0.8 to 1.2, and M represents one or more elements selected from the group consisting of transition metal elements.

In formula (1), x is preferably from 0.8 to 1.2, more preferably from 0.9 to 1.1, and still more preferably 1.0. Moreover, y is preferably from 0.9 to 1.1 and more preferably 1.0.

In the present invention, M represents one or more elements selected from the group consisting of transition metal elements. Examples of the transition metal elements include Ti, V, Cr, Mn, Fe, Co, Ni, and Cu. From the viewpoint of increasing the discharge capacity of a sodium secondary battery, M is preferably a transition metal element that can take a divalent form. From the viewpoints of providing an inexpensive secondary battery having a higher discharge capacity, M preferably comprises Fe or M or both, and M is more preferably Fe or M or both.

An example of the space group of the crystal structure of a transition metal phosphate includes a space group selected from among P222, P222₁, P2₁2₁2, P2₁2₁2₁, C222₁, C222, F222, I222, I2₁2₁2₁, Pmm2, Pmc2₁, Pcc2, Pma2, Pca2₁, Pnc2, Pmn2₁, Pba2, Pna2₁, Pnn2, Cmm2, Cmc2₁, Ccc2, Amm2, Abm2, Ama2, Aba2, Fmm2, Fdd2, Imm2, Iba2, Ima2, Pmmm, Pnnn, Pccm, Pban, Pmma, Pnna, Pmna, Pcca, Pbam, Pccn, Pbcm, Pnnm, Pmmn, Pbcn, Pbca, Pnma, Cmcm, Cmca, Cmmm, Cccm, Cmma, Ccca, Fmmm, Fddd, Immm, Ibam, Ibca and Imma. From the viewpoint of increasing the capacity of the sodium secondary battery, the transition metal phosphate of the present invention preferably has an orthorhombic crystal structure. The space group of the orthorhombic crystal structure is preferably a space group Pnma. Examples of the transition metal phosphates having the orthorhombic crystal structure of the space group Pnma include NaFePO₄, and NaMnPO₄. In the present invention, the maximum peak of a transition metal phosphate in the X-ray diffraction pattern preferably belongs to a (121) plane of the space group Pnma. For example, the maximum peak of NaFePO₄ belongs to the (121) plane of the space group Pnma, and the corresponding peak appears in the vicinity of 2θ=33°.

The transition metal phosphate of the present invention preferably has a BET specific surface area of from 40 m²/g to 80 m²/g. By setting the BET specific surface area to 40 m²/g or more, the discharge capacity of the sodium secondary battery becomes larger. By setting the BET specific surface area to 80 m²/g or less, the filling property of the transition metal phosphate in the electrode can be improved. The BET specific surface area of the transition metal phosphate is preferably from 45 m²/g to 70 m²/g.

### <Production Method for Transition Metal Phosphate>

The following description will discuss a method for producing a transition metal phosphate of the present invention.

The transition metal phosphate of the present invention can be produced by the following deposition reaction. Respective aqueous solutions containing respective metal elements corresponding to a transition metal phosphate and an aqueous solution containing phosphorus are made in contact with one another to be mixed so that a deposition product is generated, and the deposition product is heated so that a transition metal phosphate is produced. Each aqueous solution containing each of the metal elements can be obtained by dissolving a compound of each metal element in water. An aqueous solution containing phosphorus can be obtained by dissolving a phosphorus compound in water. The heating temperature is, for example, approximately from 100 to 200° C., and the heating time is, for example, approximately from 5 minutes to 1 hour, while it also depends on the size of a container.

A method of producing a sodium iron phosphate represented by NaFePO₄ that is one of preferable compositions is carried out, for example, through the following processes: sodium hydroxide, a tetrahydrate of ferric chloride (II) and diammonium hydrogenphosphate are precisely weighed so as to have a molar ratio of Na:Fe:P of 4:1:1; the respective compounds precisely weighed are subsequently dissolved in ion-exchange water to prepare respective aqueous solutions; the respective aqueous solutions are made in contact with one another and mixed with one another to generate a deposition product; and the deposition product is then heated and solid-liquid separated to produce NaFePO₄.

A method of producing a sodium manganese phosphate represented by NaMnPO₄ that is another preferable composition is carried out, for example, through the following processes: sodium hydroxide, a hexahydrate of manganese chloride (II) and diammonium hydrogenphosphate are precisely weighed so as to have a molar ratio of Na:Mn:P of 4:1:1; the respective compounds precisely weighed are subsequently dissolved in ion-exchange water to prepare respective aqueous solutions; the respective aqueous solutions are made in contact with one another and mixed with one another to generate a deposition product; and the deposition product is then heated and solid-liquid separated to produce NaMnPO₄.

A method of producing a sodium manganese-iron phosphate represented by NaMnₓFe₁₋ₓPO₄ is carried out, for example, through the following processes: sodium hydroxide, a hexahydrate of manganese chloride (II), a tetrahydrate of ferric chloride (II) and diammonium hydrogenphosphate are precisely weighed so as to have a molar ratio of Na:Mn:Fe:P of 4:x:(1-x):1; the respective compounds precisely weighed are subsequently dissolved in ion-exchange water to prepare respective aqueous solutions; the respective aqueous solutions are made in contact with one another and mixed with one another to generate a deposition product; and the deposition product is then heated and solid-liquid separated to produce NaMnₓFe₁₋ₓPO₄.

In the above-mentioned method, the molar ratio of Na in weighing is greater than a stoichiometric ratio of Na in the resulting NaMPO₄ composition. This is one essential factor of the method.

Examples of compounds containing the respective elements of Na, M (wherein M represents one or more elements selected from the group consisting of transition metal elements) and P include metal materials, oxides, hydroxides, oxyhydroxides, carbonates, sulfates, nitrates, acetates, halides, ammonium salts, oxalates, phosphates, and alkoxides. In the case where the compound is hardly dissolved in water, for example, in the case where the compound is a metal material, an oxide, a hydroxide, an oxyhydroxide, a carbonate, or the like, the compound may be dissolved in an aqueous solution containing hydrochloric acid, sulfuric acid, nitric acid, acetic acid, phosphoric acid or the like. Preferable examples of the compound containing Na include hydroxides and/or carbonates, preferable examples of the compound containing M include chlorides and/or nitrates, and preferable examples of the compound containing P include phosphoric acid and/or ammonium phosphates. Mixed compounds containing two or more elements described above may be used.

In order to stabilize M such as Fe and Mn in the aqueous solution as divalent ions, the aqueous solution preferably contains a reducer. Examples of the reducer include ascorbic acid, oxalic acid, tin chloride, potassium iodide, sulfur dioxide, hydrogen peroxide, and aniline, preferably ascorbic acid and aniline, and more preferably ascorbic acid.

The value of I/I₀ can be controlled by the heating temperature and heating time of the deposition product. As the heating time becomes shorter, the value of I/I₀ tends to become smaller, and as the heating time becomes longer, the value of I/I₀ tends to become greater. As the heating temperature becomes lower, the value of I/I₀ tends to become smaller, and as the heating temperature becomes higher, the value of I/I₀ tends to become greater. The solid-liquid separation process after the heating process of the deposition product can be carried out by an operation such as filtration, centrifugal separation, and liquid evaporation. The resulting solid matter from the solid-liquid separation process may be washed. A solvent to be used for the washing process is preferably water, more preferably pure water and/or ion-exchange water. After the washing process, the solid matter may be dried. The temperature of the drying process is preferably in a range from 20° C. to 200° C. The ambient atmosphere at the time of drying is not particularly limited, and the drying process may be carried out under normal pressure or a reduced pressure. The washing and drying processes may be repeated two or more times.

A pulverizing process, a classifying process, or the like may be carried out on the transition metal phosphate by using a ball mill, a vibration mill, and a jet mill, so that the grain size of the transition metal phosphate may be adjusted. The pulverizing, classifying, washing and drying processes may be repeated two or more times.

Within a range without impairing the effects of the present invention, one portion of the above-mentioned Na, P and M in the transition metal phosphate of the present invention may be substituted with another element. Examples of the other element include Li, B, C, N, F, Mg, Al, Si, S, Cl, K, Ca, Sc, Zn, Ga, Ge, Rb, Sr, Y, Zr, Nb, Mo, Tc, Ru, Pd, Rh, Ag, In, Sn, I, Ba, Hf, Ta, W, Ir, and Ln (rare-earth elements).

The transition metal phosphate may be surface-treated. The surface treatment is, for example, a treatment in which a transition metal phosphate is used as a core material, and a compound containing one or more elements selected from the group consisting of B, Al, Mg, Ga, In, Si, Ge, Sn, Nb, Ta, W, Mo and transition metal elements is adhered to the surface of the core material. Among these elements, one or more elements selected from the group consisting of B, Al, Mg, Mn, Fe, Co, Ni, Nb, Ta, W and Mo are preferable, and from the viewpoint of operability, Al is more preferable. Examples of the compound include oxides, hydroxides, oxyhydroxides, carbonates, nitrates, and organic acid salts of the above-mentioned elements or mixtures thereof. Among these, oxides, hydroxides, oxyhydroxides, carbonates, or mixtures thereof are more preferable. Among these, alumina is still more preferable. Moreover, the transition metal phosphate after having been subjected to the surface treatment may be subjected to a heating treatment. In some cases, the BET specific surface area of the transition metal phosphate after the surface treatment is different from that prior to the treatment; and in such a case, the BET specific surface area of the transition metal phosphate is defined as that prior to the treatment.

The above-mentioned transition metal phosphate or the transition metal phosphate subjected to the surface treatment can be used as a positive electrode active material in a sodium secondary battery.

### <Electrode Having Transition Metal Phosphate; Positive Electrode>

The following description will discuss an electrode having a transition metal phosphate of the present invention. The electrode of the present invention is desirably used as a positive electrode in a sodium secondary battery. The electrode of the present invention is referred to also as a positive electrode in the following description.

The positive electrode is produced by supporting a positive electrode mixture including a transition metal phosphate (positive electrode active material) of the present invention, a conductive material and a binder onto a positive electrode collector. In this case, the positive electrode for a sodium secondary battery has a conductive material. Examples of the conductive material include a carbonaceous material. Examples of the carbonaceous material include graphite powder, carbon black, acetylene black, and a fiber-state carbonaceous material. Carbon black or acetylene black is in the form of fine particles with a large surface area. When a small amount of the carbon black or acetylene black is added to the positive electrode mixture, the conductivity inside the positive electrode becomes higher so that the charging/discharging efficiency and rate characteristic of a secondary battery are improved. However, in the case where too much of the carbon black or acetylene black is added to the positive electrode mixture, the bonding property of the binder, which exerted between the positive electrode mixture and the positive electrode collector, is lowered, causing an increase in resistivity inside the positive electrode. The ratio of the conductive material in the positive electrode mixture is normally from 5 parts by weight to 30 parts by weight based on 100 parts by weight of the positive electrode active material. When the conductive material is produced as a fiber-state carbonaceous material, this ratio can be lowered.

From the viewpoint of enhancing the conductivity of the positive electrode for the sodium secondary batter, the conductive material preferably contains a fiber-state carbonaceous material in some cases. In the case where such a fiber-state carbonaceous material is contained, supposing that the length of the fiber-state carbonaceous material is “a” and that the diameter on a cross-section perpendicular to the length direction of the material is “b”, the value of a/b is normally from 20 to 1000. Supposing that the length of the fiber-state carbonaceous material is “a” and that the average particle diameter (D50) on the volume basis of primary particles and aggregated particles of the primary particles of the transition metal phosphate of the present invention is “c”, the value of a/c is normally from 2 to 100, and more preferably from 2 to 50. When a/c is lower than 2, the conductivity between particles in the positive electrode active material may become insufficient in some cases, while when a/c exceeds 100, the bonding property between the positive electrode mixture and the positive electrode collector may be lowered in some cases. It is preferable that the electric conductivity of the fiber-state carbonaceous material be higher. The electric conductivity of the fiber-state carbonaceous material is determined by measuring the electric conductivity of a sample prepared by molding a fiber-state carbonaceous material so as to have a density of from 1.0 to 1.5 g/cm³, and the electric conductivity of the fiber-state carbonaceous material is normally 1 S/cm or more, and preferably 2 S/cm or more.

Specific examples of the fiber-state carbonaceous material include graphitized carbon fibers and carbon nanotubes. Either single-wall carbon nanotubes or multi-wall carbon nanotubes may be used. With respect to the fiber-state carbonaceous materials, those commercial products may be pulverized so as to be adjusted within the above-mentioned ranges of a/b and a/c, and used. The pulverizing process may be either a dry pulverizing process or a wet pulverizing process, an example of the dry pulverizing process includes a pulverizing process using a ball mill, a rocking mill or a planetary-type ball mill, and an example of the wet pulverizing process includes a pulverizing process using a ball mill and a disperser. Examples of the disperser include a Dispermat (trade name, manufactured by Eko Instruments Co., Ltd.).

In the positive electrode for the sodium secondary battery of the present invention, in the case of using a fiber-state carbonaceous material, the ratio of the fiber-state carbonaceous material is preferably from 0.1 part by weight to 30 parts by weight relative to 100 parts by weight of the positive electrode active material from the viewpoint of improving the conductivity of the positive electrode. As the conductive material, the fiber-state carbonaceous material and the other carbonaceous material (graphite powder, carbon black, and acetylene black.) may be used in combination. In this case, the carbonaceous material other than the fiber-state carbonaceous material is preferably in the form of a spherical fine particle. In the case of using a carbonaceous material other than the fiber-state carbonaceous material in combination, the ratio of the carbonaceous material other than the fiber-state carbonaceous material is preferably from 0.1 part by weight to 30 parts by weight relative to 100 parts by weight of the positive electrode active material.

Examples of the binder include a thermoplastic resin, and specific examples of the thermoplastic resin include fluorine resins such as polyvinylidene fluoride (hereinafter, sometimes referred to as PVdF), polytetrafluoroethylene (hereinafter, sometimes referred to as PTFE), tetrafluoroethylene-hexafluoropropylene-vinylidene fluoride copolymers, hexafluoropropylene-vinylidene fluoride copolymers and tetrafluoroethylene-perfluorovinyl ether copolymers; and polyolefin resins such as polyethylene and polypropylene. Two or more kinds of these resins may be mixed and used with one another. A fluorine resin and a polyolefin resin may be used as the binder, and by allowing the positive electrode mixture to contain these resins so as to have a ratio of the fluorine resin in a range from 1% by weight to 10% by weight as well as a ratio of the polyolefin resin in a range from 0.1% by weight to 2% by weight relative to the positive electrode mixture, a positive electrode mixture having an excellent bonding property to the positive electrode collector can be obtained.

Examples of the positive electrode collector include Al, Ni, and stainless steel, and Al is preferable from the viewpoints of being easily formed into a thin film and of low costs. Examples of a method of supporting the positive electrode mixture on the positive electrode collector include a pressure molding method and a method in which a positive electrode mixture paste is obtained by further using an organic solvent or the like, and the paste is applied to the positive electrode collector, followed by drying, and the resulting sheet is pressed so that the positive electrode mixture is anchored to the collector. The paste contains a positive electrode active material, a conductive material, a binder and an organic solvent. Examples of the organic solvent include amine-based solvents such as N,N-dimethylaminopropylamine and diethylenetriamine, ether-based solvents such as tetrahydrofuran, ketone-based solvents such as methylethyl ketone, ester-based solvents such as methyl acetate, and amide-based solvents such as dimethyl acetoamide and N-methyl-2-pyrrolidone (hereinafter, sometimes referred to as NMP).

Examples of a method of applying the positive electrode mixture paste onto the positive electrode collector include a slit-die coating method, a screen coating method, a curtain coating method, a knife coating method, a gravure coating method, and an electrostatic spraying method. By using the processes as described above, a positive electrode for a sodium secondary battery can be produced.

### <Sodium Secondary Battery>

In the case where a sodium secondary battery has separators, the sodium secondary battery is produced through processes in which an electrode group obtained by stacking or stacking and winding the positive electrode, a separator, a negative electrode and a separator in this order, is housed in a battery case such as a battery can, and an electrolytic solution composed of an organic solvent containing an electrolyte is injected into the case. In the case of a sodium secondary battery without a separator, the sodium secondary battery is, for example, produced through processes in which an electrode group obtained by stacking or stacking and winding the positive electrode, a solid-state electrolyte, a negative electrode and the solid-state electrolyte in this order, is housed in a battery case such as a battery can.

Examples of the shape of the electrode group include shapes having a cross section such as a circular shape, an elliptical shape, a rectangular shape or a rectangular shape with round corners when the group of electrodes was cut in the direction perpendicular to the axis of winding of the group of electrodes. Examples of the shape of the battery include shapes such as a paper shape, a coin shape, a cylinder shape, and a rectangular shape.

### <Negative Electrode>

The negative electrode can be doped and dedoped with sodium ions at a potential lower than that of the positive electrode. Examples of the negative electrode include an electrode formed by supporting a negative electrode mixture containing a negative electrode material on a negative electrode collector, or an electrode made of solely a negative electrode material. Examples of the negative electrode material include materials which can be doped and dedoped with sodium ions at a potential lower than that of the positive electrode, among a carbonaceous material, a chalcogen compound (an oxide and a sulfide.), a nitride, a metal and an alloy. These negative electrode materials may be mixed with one another.

The negative electrode material is exemplified in the following materials. Specific examples of the carbonaceous material include materials which can be doped and dedoped with sodium ions at a potential lower than that of the positive electrode, among graphites such as natural graphite and artificial graphite, corks, carbon black, thermally decomposable carbons, carbon fibers and polymer sintered products. These carbonaceous materials, oxides, sulfides and nitrides may be used in combination, and either crystalline or amorphous materials of these may be used. Each of these carbonaceous materials, oxides, sulfides and nitrides is mainly supported on a negative electrode collector, and used as an electrode.

Specific examples of the metal that can be doped and dedoped with sodium ions at a potential lower than that of the positive electrode include sodium metal, silicon metal and tin metal. Specific examples of the alloy that can be doped and dedoped with sodium ions at a potential lower than that of the positive electrode include sodium alloys such as Na—Al, Na—Ni and Na—Si, silicon alloys such as Si—Zn, tin alloys such as Sn—Mn, Sn—Co, Sn—Ni, Sn—Cu and Sn—La, and other alloys such as Cu₂Sb and La₃Ni₂Sn₇. Each of these metals and alloys is mainly used solely as an electrode (for example, as a foil).

The negative electrode mixture may contain a binder, if necessary. Examples of the binder include a thermoplastic resin. Specific examples of the thermoplastic resin include PVDF, thermoplastic polyimide, carboxymethyl cellulose, polyethylene, and polypropylene. In the case where the electrolytic solution contains no ethylene carbonate to be described later, if a negative electrode mixture containing polyethylene carbonate is used, the resulting battery tends to have improved cycling characteristic and large-current discharging characteristic in some cases.

Examples of the negative electrode collector include Cu, Ni, and stainless steel, and from the viewpoints of hardly forming an alloy with sodium and of being easily processed into a thin film, Cu is preferable. Examples of the method for supporting the negative electrode mixture onto the negative electrode collector include the same methods as those of the positive electrode may be used, that is, a pressure molding method, and a method in which a negative electrode mixture paste is obtained by further using a solvent or the like, and the paste is applied to the negative electrode collector, followed by drying, and the resulting sheet is pressed so that the negative electrode mixture is anchored to the collector.

### <Separator>

Examples of the separator include members having various material modes such as a porous film, a nonwoven cloth, and a woven cloth made from materials such as polyolefin resins including polyethylene, and polypropylene, fluorine resins, and nitrogen-containing aromatic copolymers. The separator may be made from two or more kinds of the above-mentioned materials, or may be a laminated separator in which the above-mentioned members are stacked. Examples of the separator include those separators disclosed in JP2000-30686A and JP10-324758A. From the viewpoint of increasing the volume energy of the battery with a reduction in an inner resistance, the thickness of the separator is normally about from 5 to 200 μm, and preferably from about from 5 to 40 μm. The separator is preferably made as thin as possible, as long as its mechanical strength can be maintained.

The separator preferably includes a porous film containing a thermoplastic resin. In a secondary battery, the separator is disposed between the positive electrode and the negative electrode. The separator preferably has such a function that, when an abnormal current flows in a battery due to a short circuit or the like between positive and negative electrodes, it interrupts the current to prevent an excessive current from flowing therethrough (shutdown). Therefore, the separator is preferably designed to became shutdown at a temperature as low as possible when a normally used temperature is exceeded (that is, when the separator has a porous film containing a thermoplastic resin, fine pores of the porous film are clogged), and is also preferably designed such that even when, after the shutdown, the temperature inside the battery rises to a certain degree of high temperature, the shutdown state is maintained without being film-ruptured by the temperature, that is, so as to have a high temperature-resistant property. Examples of such a separator include porous films having a heat resistant material such as a laminated film in which a heat resistant porous layer and a porous film are stacked on each other, and preferably a laminated film in which a heat resistant porous layer containing a heat resistant resin and a porous film containing a thermoplastic resin are stacked on each other; thus, by using such a porous film containing a heat resistant material as the separator, the thermally film-rupturing by the temperature is further prevented. The heat resistant porous layers may be stacked on both surfaces of the porous film.

The following description will discuss a separator composed of the laminated film in which the heat resistant porous layer containing a heat resistant resin and the porous film containing a thermal plastic resin are stacked on each other. In this case, the thickness of the separator is normally from 5 μm to 40 μm, and more preferably from 5 μm to 20 μm. Supposing that the thickness of the heat resistant porous layer is A(μm) and that the thickness of the porous film is B(μm), the value of A/B is preferably from 0.1 to 1. From the viewpoint of improving the ion permeability, the separator preferably has a Gurley gas permeability of from 50 to 300 seconds/100 cc, and more preferably from 50 to 200 seconds/100 cc. The porosity of the separator is normally from 30 to 80% by volume, and more preferably from 40 to 70% by volume.

In the laminated film, the heat resistant porous layer preferably contains a heat resistant resin. In order to further improve the ion permeability, the thickness of the heat resistant porous layer is made as thin as possible, specifically, preferably from 1 μm to 10 μm, more preferably from 1 μm to 5 μm, and still more preferably from 1 μm to 4 μm. The heat resistant porous layer has fine pores, and the size (diameter) of the pore is normally 3 μm or less, and more preferably 1 μm or less. The heat resistant porous layer may contain a filler to be described later. The heat resistant porous layer may be made from inorganic powder.

Examples of the heat resistant resin contained in the heat resistant porous layer include polyamide, polyimide, polyamideimide, polycarbonate, polyacetal, polysulfone, polyphenylene sulfide, polyetherketone, aromatic polyester, polyether sulfone and polyether imide. From the viewpoint of further improving the heat resistant property, the heat resistant resin is preferably polyamide, polyimide, polyamideimide, polyether sulfone and polyether imide, more preferably polyamide, polyimide and polyamideimde, still more preferably nitrogen-containing aromatic polymers such as aromatic polyamides (para-oriented aromatic polyamides, meta-oriented aromatic polyamides), aromatic polyimides, aromatic polyamideimides, and particularly preferably aromatic polyamides. From the viewpoint of production, para-oriented aromatic polyamides (hereinafter, sometimes referred to as “para-aramide”) are particularly preferable. Moreover, examples of the heat resistant resin include poly-4-methylpentene-1 and cyclic olefin-based polymers. By using these heat resistant resins, the heat resistant property of the laminated film, that is, the thermal film-rupturing temperature of the laminated film can be improved.

The thermal film-rupturing temperature of the laminated film depends on the kind of the heat resistant resin, and is selected and used in accordance with the application state and application purpose. Normally, the thermal film-rupturing temperature is 160° C. or more. In the case where the heat resistant resin is prepared as the nitrogen-containing aromatic polymer, the thermal film-rupturing temperature is controlled to 400° C., and in the case where poly-4-methylpentene-1 is used as the heat resistant resin, it can be controlled to about 250° C., and in the case where a cyclic olefin-based polymer is used as the heat resistant resin, it can be controlled to about 300° C., respectively. In the case where the heat resistant porous layer is made from inorganic powder, the thermal film-rupturing temperature can be controlled to, for example, 500° C. or more.

The para-amide can be obtained by condensation polymerization between a para-oriented aromatic diamine and a para-oriented aromatic dicarboxylic acid halide, and its amide bonds are virtually composed of repeating units bonded at the para position or corresponding oriented position of an aromatic ring (for example, an oriented position extending coaxially in the opposite direction or in parallel therewith such as 4,4′-biphenylene, 1,5-naphthalene, and 2,6-naphthalene.). Specific examples thereof include para-aramides having a para-oriented structure or a structure corresponding to the para-oriented type such as poly(paraphenylene terephthal amide), poly(parabenzamide), poly(4,4′-benzanilide terephthalamide), poly(paraphenylene-4,4′-biphenylene dicarboxylic acid amide), poly(paraphenylene-2,6 naphthalene dicarboxylic acid amide), poly(2-chloro-paraphenylene terephthalamide), and paraphenylene terephthalamide/2,6-dichloroparaphenylene terephthal amide copolymer.

The aromatic polyimide is preferably a total aromatic polyimide produced by condensation polymerization between an aromatic dianhydride and a diamine. Specific examples of the dianhydride include pyromellitic dianhydride, 3,3′,4,4′-diphenylsulfonetetracarboxylic dianhydride, 3,3′,4,4′-benzophenonetetracarboxylic dianhydride, 2,2′-bis(3,4-dicarboxyphenyl)hexafluoropropane and 3,3′,4,4′-biphenyltetracarboxylic dianhydride. Specific examples of the diamine include oxydianiline, paraphenylene diamine, benzophenone diamine, 3,3′-methylene dianiline, 3,3′-diaminobenzophenone, 3,3′-diaminodiphenyl sulfone and 1,5-naphthalene diamine. Moreover, a polyimide that is soluble to the solvent is desirably used. Examples of the polyimide include a polyimide of a polycondensation product between 3,3′,4,4′-diphenylsulfonetetracarboxylic dianhydride and an aromatic diamine.

Examples of the aromatic polyamideimide include a condensation polymerization product between an aromatic dicarboxylic acid and an aromatic diisocyanate, and a condensation polymerization product between an aromatic dianhydride and an aromatic diisocyanate. Specific examples of the aromatic dicarboxylic acid include an isophthalic acid and a terephthalic acid. Specific examples of the aromatic dianhydride include a trimellitic anhydride. Specific examples of the aromatic diisocyanate include 4,4′-diphenyl methane diisocyanate, 2,4-tolylene diisocyanate, 2,6-tolylene diisocyanate, orthotolylene diisocyanate, and m-xylene diisocyanate.

In the case where the heat resistant porous layer contains a heat resistant resin, the heat resistant porous layer may contain one or more kinds of fillers. The material for the filler to be contained in the heat resistant porous layer may be one or more kinds of materials selected from the group consisting of organic powder, inorganic powder and a mixture of these. Particles forming the filler preferably have an average particle size of from 0.01 μm to 1 μm. Examples of the filler shape include a virtually spherical shape, a plate shape, a pillar shape, a needle shape, a whisker shape, and a fiber shape, and from the viewpoint of easily forming uniform pores, a virtually spherical shape is preferable. Examples of the virtually spherical particles include particles having an aspect ratio (major axis of particles/minor axis of the particles) of particles of from 1 to 1.5. The aspect ratio of the particles can be measured by using an electron microscope photograph.

Examples of the organic powder for use as the filler include powders made from organic substances such as single or two or more kinds of copolymers among styrene, vinylketone, acrylonitrile, methyl methacrylate, ethyl methacrylate, glycidyl methacrylate, glycidyl acrylate, and methylacrylate; fluorine resins such as polytetrafluoroethylene, a tetrafluoroethylene-hexafluoropropylene copolymer, a tetrafluoroethylene-ethylene copolymer and polyvinylidene fluoride; melamine resins; urea resins; polyolefin; and polymethacrylate. One of these organic powders may be solely used, or two or more kinds thereof may be used in combination. From the viewpoint of chemical stability, among these organic powders, powder of polytetrafluoroethylene is preferable.

Examples of the inorganic powder for use as a filler include powders made from inorganic substances such as metal oxides, metal nitrides, metal carbonates, metal hydroxides, carbonates, and sulfates. Among these, powders made from inorganic substances having a low conductivity are preferable. Specific examples of the inorganic powders include powders such as alumina, silica, titanium dioxide, barium sulfate, and calcium carbonate. One of these inorganic powders may be used solely, or two or more kinds thereof may be used in combination. Among these inorganic powders, from the viewpoint of chemical stability, an alumina powder is preferable. More preferably all the particles forming the alumina powder are alumina particles, and furthermore preferably all the particles forming the filler are prepared as alumina particles, with a portion or all portions of the alumina particles being formed into a virtually spherical shape. In the case where the heat resistant porous layer is made from inorganic powder, the above-exemplified inorganic powders may be used, and may be mixed with a binder, if necessary, and used.

In the case where the heat resistant porous layer contains a heat resistant resin, the content of the filler is dependent on the specific gravity of the material of the filler. For example, when all particles forming the filler are alumina particles, the content of the filler is normally from 5 to 95, more preferably from 20 to 95, furthermore preferably from 30 to 90, relative to the total weight 100 of the heat resistant porous layer. These ranges can be appropriately determined depending on the specific gravity of the filler material.

The porous film in the laminated film has fine pores. The porous film preferably has a shutdown function, and in this case it contains a thermoplastic resin. The thickness of the porous film is normally from 3 to 30 μm, and preferably from 3 to 25 μm. The size of the pores of the porous film is normally 3 μm or less, and preferably 1 μm or less. The rate of porosity of the porous film is normally from 30 to 80% by volume, and preferably from 40 to 70% by volume. In the case where a secondary battery is used at a temperature exceeding a normally used temperature, the porous film is allowed to clog the fine pores by softening the thermoplastic resin by which it is formed.

Examples of the thermoplastic resin to be contained in the porous film include those resins softened at from 80 to 180° C., and those resins that are insoluble to the electrolytic solution of the secondary. Specific examples of the thermoplastic resin include polyolefin resins such as polyethylene, and polypropylene, and thermoplastic polyurethane resins, and two or more kinds of the thermoplastic resins may be used. From the viewpoint of being softened at a lower temperature to cause a shutdown, the porous film preferably contains a polyethylene. Specific examples of the polyethylene include a low-density polyethylene, a high-density polyethylene and a linear polyethylene, and an ultra-high molecular weight polyethylene having a molecular weight of 1,000,000 or more. From the viewpoint of further increasing the piercing strength of the porous film, the porous film preferably contains an ultra-high molecular weight polyethylene. In order to easily produce the porous film, the thermoplastic resin may be preferably allowed to contain a wax made from polyolefin having a low molecular weight (weight-average molecular weight of 10,000 or less) in some cases.

Examples of the porous film having a heat resistant material include porous films made from a heat resistant resin and/or inorganic powder, and porous films, formed by dispersing the heat resistant resin and/or inorganic powder in a thermoplastic resin film such as a polyolefin resin and a thermoplastic polyurethane resin. Examples of the heat resistant resin and inorganic powder include those shown above as examples.

### <Electrolytic Solution>

In the electrolytic solution, examples of the electrolyte include sodium salts such as NaClO₄, NaPF₆, NaAsF₆, NaSbF₆, NaBF₄, NaCF₃SO₃, NaN(SO₂CF₃)₂, NaN(SO₂C₂F₅)₂, NaN(SO₂CF₃)(COCF₃), Na(C₄F₉SO₃), NaC(SO₂CF₃)₃, Na₂B₁₀Cl₁₀, NaBOB (in this case, BOB represents bis(oxalato)borate), lower fatty carboxylic acid salts and NaAlCl₄, and two or more kinds of these electrolytes may be used in combination. Among these sodium salts, at least one kind of fluorine-containing sodium salt selected from the group consisting of NaPF₆, NaAsF₆, NaSbF₆, NaBF₄, NaCF₃SO₃, NaN(SO₂CF₃)₂ and NaC(SO₂CF₃)₃ is preferable.

In the electrolytic solution, examples of the organic solvent include carbonates such as propylene carbonate (hereinafter, sometimes referred to as PC), ethylene carbonate, dimethyl carbonate, diethyl carbonate, vinylene carbonate, isopropylmethyl carbonate, propylmethyl carbonate, ethylmethyl carbonate, 4-trifluoromethyl-1,3-dioxolan-2-one and 1,2-di(methoxycarbonyloxy)ethane; ethers such as 1,2-dimethoxyethane, 1,3-dimethoxypropane, pentafluoropropyl methylether, 2,2,3,3-tetrafluoropropyl difluoromethylether, tetrahydrofuran and 2-methyl tetrahydrofuran; esters such as methyl formate, methyl acetate and γ-butyrolactone; nitriles such as acetonitrile and butyronitrile; amides such as N,N-dimethylformamide and N,N-dimethylacetoamide; carbamates such as 3-methyl-2-oxazolidone; sulfur-containing compounds such as sulforan, dimethylsulfoxide and 1,3-propane sultone, and those solvents formed by further introducing a fluorine substitute to the above-mentioned organic solvents. A mixed solvent which contains two or more kinds of these organic solvents may be used. Among these mixed solvents, a mixed solvent containing carbonates is preferable, and a mixed solvent containing a cyclic carbonate and an acyclic carbonate, or a mixed solvent containing a cyclic carbonate and ethers is more preferable.

### <Solid-State Electrolyte>

In place of the electrolytic solution, a solid-state electrolyte may be used. Examples of the solid-state electrolyte include organic solid-state electrolytes such as polyethylene oxide-based polymers or polymers containing at least one or more kinds of a polyorganosiloxane chain and a polyoxyalkylene chain. A so-called gel-type in which an electrolytic solution is held on a polymer may also be used. Inorganic solid-state electrolytes such as Na₂S—SiS₂, Na₂S—GeS₂, Na₂S—P₂S₅, Na₂S—B₂S₂, Na₂S—SiS₂—Na₃PO₄ and Na₂S—SiS₂—Na₂SO₄, may also be used. Examples of the inorganic solid-state electrolyte, NASICON-type electrolytes such as NaZr₂(PO₄)₃, may also be used. By using these solid-state electrolytes, higher safety may be further ensured in some cases. In the case where a solid-state electrolyte is used for the sodium secondary battery of the present invention, the solid-state electrolyte occasionally serves as a separator, and in this case no separator is required.

### EXAMPLES

The following description will further discuss the present invention in detail by means of examples. The present invention is not intended to be limited by these. Powder X-ray diffraction measurements and measurements of BET specific surface were carried out by the following methods. Production of an electrode and a sodium secondary battery for charging/discharging tests was carried out by the following methods.

### (1) Powder X-Ray Diffraction Measurements

As a powder X-ray diffraction analyzer, a powder X-ray diffractometor of type RINT 2500 TTR manufactured by Rigaku Corporation was used. An X-ray diffraction pattern was produced by delivering a Cu Kα ray to a mixture composed of the transition metal phosphate and silicon in a transition metal phosphate:silicon weight ratio of 8:1, and then a value of I/I₀ was determined by dividing I by I₀ where I is the intensity of a maximum peak of the transition metal phosphate and I₀ is the intensity of the maximum peak of the silicon in the X-ray diffraction pattern. As the silicon, 640c Silicon Powder manufactured by National Institute of Standards and Technology (NIST) was used.

X-ray source: Cu Kα ray
Voltage-current: 40 kV-140 mA
Measuring angle range: 2θ=10 to 90°

### Step: 0.02°

Scanning speed: 4°/min
Divergence slit width (DS): 1°
Scattering slit width (SS): 1°
Light receiving slit width (RS) 0.3 mm

### (2) Measurements of BET Specific Surface Area of Transition Metal Phosphate

After drying about 1 g of powder of a transition metal phosphate in a nitrogen gas flow at 150° C. for 15 minutes, the BET specific surface area of the transition metal phosphate was measured using a Flowsorb II2300 manufactured by Micrometrics Ltd.

### (3) Composition Analysis of Transition Metal Phosphate

After dissolving powder of a transition metal phosphate in a hydrochloric acid, a composition of the transition metal phosphate was analyzed using an inductively coupled plasma atomic emission spectrophotometry (SPS3000, hereinafter, sometimes referred to as ICP-AES).

### (4) Production of Sodium Secondary Battery

Powder of a transition metal phosphate was used as a positive electrode active material. Acetylene black (hereinafter, sometimes referred to as AB), was used as a conductive material. PEFE was used as a binder. By mixing and kneading the positive electrode active material, the conductive material and the binder so as to have a ratio of positive electrode active material:AB:PTFE=75:20:5 (weight ratio) so that a positive electrode mixture was obtained, and the positive electrode mixture was applied to an SUS mesh (#100, 100φ) which is to be an electrode collector, and this was vacuum-dried at 150° C. for 8 hours so that a positive electrode was obtained. The weight of the resulting positive electrode was measured, and by subtracting the weight of the SUS mesh from the weight of the positive electrode, the weight of the positive electrode mixture was calculated so that based upon the weight ratio of the positive electrode mixture, the weight of the powder of the positive electrode active material was calculated. The resultant positive electrode, a solution prepared by dissolving NaClO₄ in PC serving as an electrolytic solution so as to be set to one mole/liter (hereinafter, sometimes referred to as NaCl₄/PC), a polyethylene porous film serving as a separator and a sodium metal serving as a negative electrode were combined with one another to produce a sodium secondary battery (R2032, coin-shaped battery).

By using the coin-shaped battery, charging/discharging tests were carried out while being kept at 25° C. under the following conditions.

### (Charging/Discharging Tests)

Charging: Charging maximum voltage 4.2 V, Constant current charging, 0.1 C rate (Charging time: 10 hours)
Discharging: Discharging minimum voltage 1.5 V, Constant current discharging, 0.1 C rate (1.5 V cutoff)

### (Discharging Rate Characteristic Test)

Charging: Charging maximum voltage 4.2 V, Constant current-constant voltage charging, 0.1 C rate
Discharging 1: Discharging minimum voltage 1.5 V, Constant current discharging, 0.1 C rate
Discharging 2: Discharging minimum voltage 1.5 V, Constant current discharging, 1 C rate

### Example 1

### (A) Synthesis of Powder S₁ of Transition Metal Phosphate

Sodium hydroxide (NaOH), diammonium hydrogenphosphate ((NH₄)₂HPO₄) and tetrahydrate of ferric chloride (II) (FeCl₂.4H₂O) were precisely weighed so as to have a molar ratio of 4:1:1 in sodium (Na):iron (Fe):phosphorus (P), and the compounds thus precisely weighed were put into glass beakers of 100 ml, respectively, and ion-exchange water was poured into the beakers so that respective aqueous solutions were obtained. To the aqueous solution of tetrahydrate of ferric chloride (II) was added 0.6 g of an ascorbic acid, and dissolved therein while being stirred. Next, to this were added the aqueous solution of sodium hydroxide and the aqueous solution of diammonium hydrogenphosphate and mixed therein while being stirred, and by adding the aqueous solution having the tetrahydrate of ferric chloride (II) and ascorbic acid dissolved therein to the resultant mixed aqueous solution, a solid/liquid mixture containing a deposition product was obtained. The resultant solid/liquid mixture was put into an eggplant flask, and after the eggplant flask was heated for 20 minutes in an oil bath set at 170° C., the solid/liquid mixture was filtered, washed with water and filtered again, and then dried so that powder S₁ of transition metal phosphate was obtained.

### (B) Various Evaluations on Powder S₁ of Transition Metal Phosphate

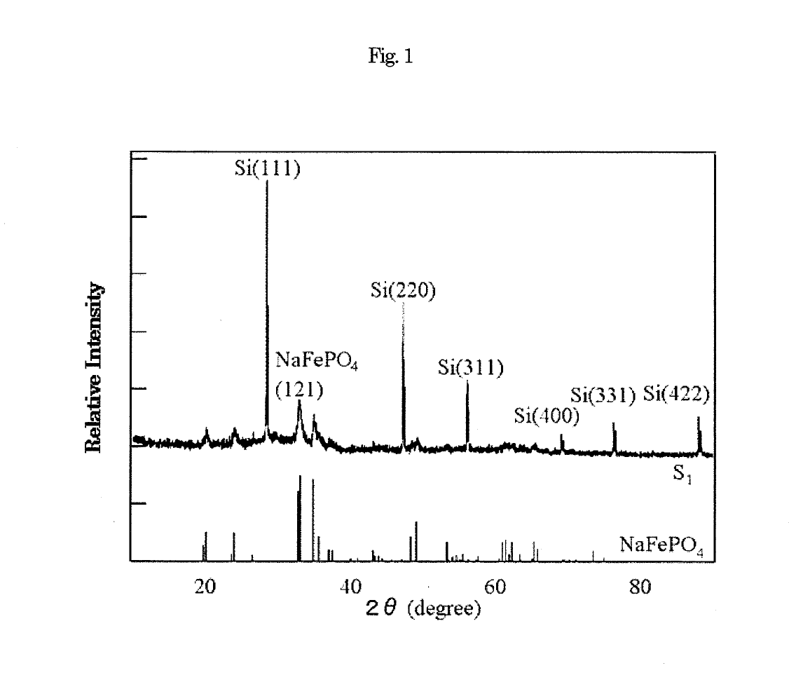

The powder S₁ and silicon were mixed at a weight ratio of 8:1. The mixing process was carried out for 2 minutes by using an agate mortar. When the resultant mixture was subjected to X-ray diffraction measurements, peaks of a single-phase orthorhombic crystal structure NaFePO₄ and Si were observed. An X-ray diffraction pattern of the powder at this time is shown in FIG. 1. In FIG. 1, the maximum peak of the powder S₁ belongs to a peak (2θ=33°) of a (121) plane of the orthorhombic crystal structure NaFePO₄ (space group: Pnma), and a full width half maximum of the peak thereof was 0.4°. Supposing that the intensity of the maximum peak of the transition metal phosphate is I and the intensity of the maximum peak of the silicon is I₀, the value of I/I₀ was 0.2. As a result of a composition analysis carried out on the powder S₁ by using ICP-AES, a molar ratio of Na:Fe:P was 1:1:1. When the BET specific surface area of the powder S₁ was measured, its BET specific surface area was 45 m²/g. When a sodium secondary battery was produced using the powder S₁ and the aforementioned charging/discharging tests were carried out thereon, it was confirmed that the secondary battery was chargeable and dischargeable, and that the discharge capacity at 0.1 C rate was 120 mAh/g, which was a large value. When the secondary battery was subjected to discharging rate characteristic tests, the discharge capacity at 1 C rate was 88 mAh/g, which was a discharge capacity of 73% relative to the discharge capacity at 0.1 C rate, confirming that a superior rate characteristic was obtained.

### Example 2

### (A) Synthesis of Powder S₂ of Transition Metal Phosphate

Sodium hydroxide (NaOH), diammonium hydrogenphosphate ((NH₄)₂HPO₄) and tetrahydrate of ferric chloride (II) (FeCl₂.4H₂O) were precisely weighed so as to have a molar ratio of 4:1:1 in sodium (Na):iron (Fe):phosphorus (P), and the compounds thus precisely weighed were put into glass beakers of 100 ml, respectively, and ion-exchange water was poured into the beakers so that respective aqueous solutions were obtained. To the aqueous solution of tetrahydrate of ferric chloride (II) was added 0.6 g of an ascorbic acid, and dissolved therein while being stirred. Next, to this were added the aqueous solution of sodium hydroxide and the aqueous solution of diammonium hydrogenphosphate and mixed therein while being stirred, and by adding the aqueous solution having the tetrahydrate of ferric chloride (II) and ascorbic acid dissolved therein to the resultant mixed aqueous solution, a solid/liquid mixture containing a deposition product was obtained. The resultant solid/liquid mixture was put into an eggplant flask, and after the eggplant flask was heated for 40 minutes in an oil bath set at 170° C., the solid/liquid mixture was filtered, washed with water and filtered again, and then dried so that powder S₂ of transition metal phosphate was obtained.

### (B) Various Evaluations on Powder S₂ of Transition Metal Phosphate

The powder S₂ and silicon were mixed at a weight ratio of 8:1. The mixing process was carried out for 2 minutes by using an agate mortar. When the resultant mixture was subjected to X-ray diffraction measurements, peaks of a single-phase orthorhombic crystal structure NaFePO₄ and Si were observed. The maximum peak of the powder S₂ belongs to a peak (2θ=33°) of a (121) plane of the orthorhombic crystal structure NaFePO₄ (space group: Pnma), and a full width half maximum of the peak thereof was 0.3°. Supposing that the intensity of the maximum peak of the transition metal phosphate is I and the intensity of the maximum peak of the silicon is I₀, the value of I/I₀ was 0.6. As a result of a composition analysis carried out on the powder S₂ by using ICP-AES, a molar ratio of Na:Fe:P was 1:1:1. When the BET specific surface area of the powder S₂ was measured, its BET specific surface area was found to be 40 m²/g. When a sodium secondary battery was produced using the powder S₂ and the aforementioned charging/discharging tests were carried out thereon, it was confirmed that the secondary battery was chargeable and dischargeable and that the discharge capacity at 0.1 C rate was 110 mAh/g, which was a large value. When the secondary battery was subjected to discharging rate characteristic tests, the discharge capacity at 1 C rate was 79 mAh/g, which was a discharge capacity of 72% relative to the discharge capacity at 0.1 C rate, confirming that a superior rate characteristic was obtained.

Even when a portion or all portions of Fe of the powder of transition metal phosphate of the present example were replaced with Mn, the same effects as those described above can be obtained.

### Comparative Example 1

### (A) Synthesis of Comparative Powder R₁

Sodium carbonate (Na₂CO₃), iron oxalate dihydrate (FeC₂O₄.2H₂O) and diammonium hydrogenphosphate ((NH₄)₂HPO₄) were precisely weighed so as to have a molar ratio of 1:1:1 in sodium (Na):iron (Fe):phosphorus (P), and mixed in an agate mortar. The resultant sample was put into an alumina crucible, and temporarily calcined in an electric furnace at 450° for 10 hours, with a nitrogen gas being allowed to flow at a flow rate of 2 liters/minute.

The sample that had been temporarily calcined was pulverized in an agate mortar, and then subjected to main calcination in an electric furnace at 800° C. for 24 hours, with a nitrogen gas being again allowed to flow at a flow rate of 5 liters/min, and the resultant sample was further pulverized by a ball mill so that powder R₁ of transition metal phosphate was obtained.

### (B) Various Evaluations on Comparative Powder R₁

The powder R₁ and silicon were mixed at a weight ratio of 8:1. The mixing process was carried out for 2 minutes by using an agate mortar. When the resultant mixture was subjected to X-ray diffraction measurements, peaks of a single-phase orthorhombic crystal structure NaFePO₄ and Si were observed. In the X-ray diffraction pattern at this time, the maximum peak of the powder R₁ belongs to a peak of a (301) plane of the orthorhombic crystal structure NaFePO₄ (space group: Pnma), and a full width half maximum of the peak thereof was 0.1°. Supposing that the intensity of the maximum peak of the transition metal phosphate is I and the intensity of the maximum peak of the silicon is I₀, the value of I/I₀ was 1.6. As a result of a composition analysis on the powder R₁ by using the ICP-AES method, a molar ratio of Na:Fe:P was 1:1:1. When the BET specific surface area of the powder R₁ was measured, its BET specific surface area was found to be 0.26 m²/g. When a sodium secondary battery was produced using the powder R₁ and the aforementioned charging/discharging tests were carried out thereon, it was confirmed that the secondary battery was chargeable and dischargeable and that the discharge capacity at 0.1 C rate was 60 mAh/g. When the secondary battery was subjected to discharging rate characteristic tests, the discharge capacity at 1 C rate was 32 mAh/g, which was a discharge capacity of 53% relative to the discharge capacity at 0.1 C rate.

### Production Example 1 (Production of Laminated Film)

### (1) Production of Coating Slurry

After 272.7 g of calcium chloride was dissolved in 4200 g of NMP, to this was added 132.9 g of paraphenylene diamine and completely dissolved therein. To the resultant solution was gradually added 243.3 g of terephthaloyl dichloride to be polymerized so that para-aramide was obtained, and this was further diluted with NMP so that a para-aramide solution (A) having a concentration of 2.0% by weight was obtained. To the resultant para-aramide solution (100 g) were added 2 g of an alumina powder (a) (alumina C, manufactured by Japan Aerosil Inc., average particle size 0.02 μm) and 2 g of an alumina powder (b) (Sumicorundum AA03, manufactured by Sumitomo Chemical Co., Ltd., average particle diameter 0.3 μm), that is, the total of 4 g, and mixed therein as fillers, and this was processed by a nano-mizer three times, and further filtered by a wire gauze with 1000 meshes, and then defoamed under reduced pressure so that a coating slurry (B) was produced. The weight of the alumina powder (filler) relative to the total weight of the paraamide and the alumina powder became 67% by weight.

### (2) Production and Evaluations of Laminated Film

As a porous film, a polyethylene porous film (film thickness 12 μm, gas permeability 140 seconds/100 ccs, average pore diameter 0.1 μm, rate of porosity 50%) was used. The polyethylene porous film was secured onto a PET film having a thickness of 100 μm, and the coating slurry (B) was applied onto the porous film by using a bar coater manufactured by Tester Sangyo Co., Ltd. The PET film and the coated porous film were immersed into water while being integrally kept so that a para-aramide porous film (heat resistant layer) was deposited thereon, and the solvent was then dried so that a laminated film 1 having the heat resistant porous layer and the porous film stacked thereon was obtained. The thickness of the laminated film 1 was 16 μm, and the thickness of the paraamide porous film (heat resistant porous layer) was 4 μm. The gas permeability of the laminated film 1 was 180 seconds/100 cc, and the rate of porosity thereof was 50%. When the cross section of the heat resistant porous layer in the laminated film 1 was observed by a scanning electron microscope (SEM), it was found that comparatively small fine pores of 0.03 μm to 0.06 μm and comparatively large fine pores of 0.1 μm to 1 μm were present. The evaluations on the laminated film were carried out by the following method.

### (Evaluation of Laminated Film)

### (A) Thickness Measurements

The thickness of the laminated film and the thickness of the porous film were measured in accordance with JIS Standard (K7130-1992). Moreover, a value obtained by subtracting the thickness of the porous film from the thickness of the laminated film was used as the thickness of the heat resistant porous layer.

### (B) Measurements of Gas Permeability by Gurley Method

The gas permeability of the laminated film was measured in accordance with JIS P8117 by using a digital timer-type Gurley type Densometer manufactured by Yasuda Seiki Seisakusho Ltd.

### (C) Rate of Porosity

The sample of the resulting laminated film was cut out into a square having a length of 10 cm in each side, and the weight W(g) and thickness D (cm) were measured. The weights of the respective layers in the sample (Wi(g); i is an integer from 1 to n) were found, and based upon Wi and the true specific gravity (true specific gravity i (g/cm³)) of the material of each layer, the volume of each of the layers was found, and the rate of porosity (volume %) was calculated from the following expression:

Rate of Porosity (volume %)=100×{1−(W1/True Specific Gravity 1+W2/True Specific Gravity 2 + . . . + Wn/True Specific Gravity n)/(10×10×D)}

In each of the examples, by using the laminated film obtained from production example 1 as a separator, a lithium secondary battery capable of increasing the thermal film-rupturing temperature can be obtained.

### INDUSTRIAL APPLICABILITY

The present invention makes it possible to provide a sodium secondary battery having a higher discharge capacity and superior rate characteristic in comparison with the conventional sodium secondary battery. The transition metal phosphate of the present invention is desirably used for a positive electrode active material of the sodium secondary battery. The sodium secondary battery of the present invention is produced with very inexpensive materials and very useful in the industrial field in comparison with the lithium secondary battery.

1. A transition metal phosphate comprising Na, P, and M where M represents one or more elements selected from the group consisting of transition metal elements, wherein a value of I/I₀ determined by the following powder X-ray diffraction measurement is 0.6 or less: the powder X-ray diffraction measurement is a method in which an X-ray diffraction pattern is produced by delivering a Cu Kα ray to a mixture composed of the transition metal phosphate and silicon in a transition metal phosphate:silicon weight ratio of 8:1, and then a value of I/I₀ is determined by dividing I by I₀ where I is the intensity of a maximum peak of the transition metal phosphate and I₀ is the intensity of the maximum peak of the silicon in the X-ray diffraction pattern.

2. The transition metal phosphate according to claim 1, wherein a full width half maximum of the maximum peak of the transition metal phosphate in the X-ray diffraction pattern is from 0.3° to 1.5°.

3. The transition metal phosphate according to claim 1 being represented by the following formula (1):
NaₓM_{y}PO₄ (1)
wherein x is more than 0 and not more than 1.5, y is from 0.8 to 1.2, and M represents one or more elements selected from the group consisting of transition metal elements.

4. The transition metal phosphate according to claim 1 having an orthorhombic crystal structure.

5. The transition metal phosphate according to claim 4, wherein the space group of the orthorhombic crystal structure is a space group Pnma and the maximum peak of the transition metal phosphate in the X-ray diffraction pattern belongs to a (121) plane of the space group Pnma.

6. The transition metal phosphate according to claim 1 having a BET specific surface area of from 40 m²/g to 80 m²/g.

7. The transition metal phosphate according to claim 1, wherein the M comprises Fe or Mn or both.

8. An electrode comprising the transition metal phosphate according to claim 1.

9. A sodium secondary battery comprising the electrode according to claim 8 as a positive electrode.
